(19) United States
(12) Patent Application Publication
(10) Pub. No.: US 2026/0159702 A1
(43) Pub. Date: Jun. 11, 2026

(54) PASSIVE RADIATIVE COOLING PAINT FORMULATION TO ACHIEVE SUBAMBIENT TEMPERATURE

(71) Applicant: University of South Florida, Tampa, FL (US)

(72) Inventors: Dharendra Yogi Goswami, Tampa, FL (US); Sudhansh Harkut, Tampa, FL (US); Krishnendu Maity, Tampa, FL (US); Samantha Wijewardane, Tampa, FL (US)

(21) Appl. No.: 19/412,447

(22) Filed: Dec. 8, 2025

Related U.S. Application Data
(60) Provisional application No. 63/729,085, filed on Dec. 6, 2024.

(51) Int. Cl. C09D 5/33; C09D 7/40; C09D 7/61; C09D 127/16; C09D 133/12; F28F 13/18

(52) U.S. Cl. CPC C09D 5/004; C09D 7/61; C09D 7/69; C09D 7/70; C09D 127/16; C09D 133/12; F28F 13/18; F28F 2245/06

(57) ABSTRACT

Described are coating compositions comprising particles comprising one or more of barium sulfate, calcium carbonate, silica, wollastonite, muscovite mica, and aluminum phosphate; and a binder comprising one or more of sodium silicate, polyvinylidene fluoride, and polymethyl methacrylate. Methods of coating articles with the disclosed compositions, and articles coated thereby, are also disclosed.

### CROSS REFERENCE TO RELATED APPLICATIONS

This application claims the benefit of priority to U.S. Provisional Application 63/729,085, filed Dec. 6, 2024, which is incorporated by reference herein in its entirety.

### BACKGROUND

Passive cooling technologies have played a significant role in human comfort since ancient times, leading to the development of many innovative solutions. Despite these advancements, a majority of today's cooling systems still depend on vapor compression, which requires refrigerants and external energy. Global energy consumption for space cooling is projected to rise significantly in the coming decades, due to population growth, urbanization, and increasing living standards. Additionally, rising global temperatures due to climate change further exacerbate the need for efficient cooling technologies. There is a pressing need for passive cooling solutions.

Solar shading, smart windows, passive ventilation techniques, radiative cooling, evaporative cooling, and earth contact cooling offer low-energy solutions for comfort cooling. Radiative cooling leverages the natural process of heat dissipation through thermal radiation, enabling buildings to cool by emitting infrared radiation into the cold night sky temperatures. To achieve radiative cooling during the day, a coating must be designed to reflect almost all the sunlight while simultaneously emitting in the atmospheric window at wavelengths between 8 to 13 micrometers. Researchers have explored various approaches, including using high-reflectivity pigments like barium sulfate, silicon oxide, calcium carbonate, titanium oxide, etc., and manipulating material properties to enhance infrared emissivity in the atmospheric window.

Paints that are mixtures of polymers and nano- and/or microparticles are attracting attention as a potential pathway for commercialization due to low cost, ease of production, and enabling scalability. These cool paints are fabricated by embedding dielectric nano- or micro particles in a polymer matrix. The particles optimize the solar reflectance by effective light scattering, while functional groups in polymers, such as C—H and C—F groups in polyvinylfluoride (PVF) and polyvinylidene-fluoride (PVDF), C—H, C═O, and C—O groups in polymethyl methacrylate (PMMA), and Si—O—Si, Si—CH₃ groups in polydimethylsiloxane (PDMS), enhance the infrared emission within the atmospheric window.

Particle sizes and distribution are critical for maximizing the solar reflectance. A hierarchical particle size distribution scatters the sunlight across a wider spectrum, enhancing the solar reflectance. Also, a wider particle size distribution that does not require precise particle size control can be achieved by low-cost fabrication processes. Other than the particle size, a high particle volume concentration can improve the solar reflectance, particularly for low-refractive-index particles such as CaCO₃.

Polymethyl methacrylate (PMMA), commonly known as acrylic emulsion, is in general considered the best polymer paint for outdoor applications due to its superior durability, flexibility, and adhesion to most substrates. Several polymer-particle radiative cooling paints have been formed using acrylic as the polymer matrix. Although these coatings have been reported to achieve sub-ambient temperatures, none of them seems to have been commercialized. Possible reasons could be high cost or low lifetimes. Therefore, there is a need to develop a high-performance, low-cost, durable, and commercially viable radiative cooling coating. The compositions and methods disclosed herein address these and other needs.

### SUMMARY

Disclosed herein, in one aspect, are compounds, compositions, and methods for making and using the disclosed compounds and compositions. In a more specific aspect, disclosed herein are coating compositions comprising particles comprising one or more of barium sulfate, calcium carbonate, silica, wollastonite, muscovite mica, and aluminum phosphate; and a binder comprising one or more of sodium silicate, polyvinylidene fluoride, and polymethyl methacrylate. Methods of coating articles with the disclosed compositions, and articles coated thereby, are also disclosed.

Additional advantages will be set forth in part in the following description and in part will be obvious from the description or may be learned by practicing the aspects described below. The advantages described below will be realized and attained by the elements and combinations pointed out in the appended claims. It is to be understood that the foregoing general description and the following detailed description are exemplary and explanatory only and are not restrictive.

### BRIEF DESCRIPTION OF THE FIGURES

FIG. 1 is a schematic showing the generation of Apollonian packing.

FIG. 2A is a SEM image of BaSO₄ particles.

FIG. 2B is a SEM image of CaCO₃ particles.

FIG. 3 is a graph of the infrared absorption spectra of BaSO₄, CaCO₃, and acrylic.

FIG. 4 is a graph showing the effect of adding water to an acrylic based coating composition.

FIG. 5 is a graph comparing the visible light reflectance of PDRC1 with commercial cool paints.

FIG. 6 is a graph showing the outdoor testing results of PDRC with commercial cool paints.

FIG. 7 is a graph showing the outdoor testing results of PDRC with commercial cool paints in comparison to ambient temperature.

### DETAILED DESCRIPTION

The following description of the disclosure is provided as an enabling teaching of the disclosure in its best, currently known aspects. Many modifications and other aspects disclosed herein will come to mind to one skilled in the art to which the disclosed compositions and methods pertain, having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual aspects described and illustrated herein has discrete components and features that may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to but does not preclude the presence or addition of one or more features, integers, steps, or components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an,” and “the” include plural referents unless the context clearly dictates otherwise.

It should be noted that ratios, concentrations, amounts, and other numerical data can be expressed herein in a range format. It can be further understood that the endpoints of each of the ranges are significant both in relation to the other endpoint and independently of the other endpoint. It is also understood that there are a number of values disclosed herein and that each value is also herein disclosed as “about” that particular value in addition to the value itself. For example, if the value “10” is disclosed, then “about 10” is also disclosed. Ranges can be expressed herein as from “about” one particular value and/or to “about” another particular value. Similarly, when values are expressed as approximations, by use of the antecedent “about,” it can be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x,’ ‘about y’, and ‘about z’ as well as the ranges of ‘less than x,’ less than y′, and ‘less than z’. Likewise, the phrase ‘about x, y, z, or greater’ should be interpreted to include the specific ranges of ‘about x,’ ‘about y,’ and ‘about z’ as well as the ranges of ‘greater than x,’ greater than y′, and ‘greater than z.’ In addition, the phrase “about ‘x’ to ‘y’,” where ‘x’ and ‘y’ are numerical values, includes “about ‘x’ to about ‘y’.”

It is to be understood that such a range format is used for convenience and brevity and, thus, should be interpreted in a flexible manner to include not only the numerical values explicitly recited as the limits of the range but also all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5% but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter, or other quantity or characteristic is “about,” “approximate,” or “at or about” whether or not expressly stated to be such. It is understood that where “about,” “approximate,” or “at or about” is used before a quantitative value, the parameter also includes the specific quantitative value itself unless specifically stated otherwise.

### Radiative Cooling

A key challenge in radiative cooling is identifying materials that can simultaneously provide high solar reflectance and effectively emit infrared radiation across the 8-13 μm wavelength atmospheric window. This disclosure addresses these challenges by exploring material combinations, such as BaSO₄ and CaCO₃, to enhance cooling performance and push the boundaries of sub-ambient temperature achievement.

Radiative cooling is considered superior among passive cooling systems due to its ability to dissipate heat from surfaces to the cooler night sky or deep space, effectively reducing indoor temperatures without dependence on environmental factors such as airflow or humidity. This mechanism operates efficiently even in regions with minimal wind or high humidity, where other passive cooling techniques, such as induced ventilation or evaporative cooling, may be less effective. Moreover, radiative cooling can be incorporated into building materials, offering a versatile and sustainable solution that enhances thermal comfort with minimal maintenance requirements.

Radiative cooling leverages the natural process of heat dissipation through thermal radiation, enabling buildings to cool by emitting infrared radiation into the cold outer space. This technology reduces reliance on conventional energy sources and mitigates global warming's adverse effects, making it a crucial advancement in sustainable cooling solutions.

Cooling below room temperature requires a coating that is designed to both emit mid-infrared radiation into space and reflect sunlight and UV rays. Not all infrared radiation emitted from Earth's surface, though, might be able to return to space with ease. Certain wavelengths are selectively absorbed by the atmosphere, which acts like a blanket. The infrared spectrum has a window between 8 and 13 micrometers where heat can be exchanged between the atmosphere and the earth. The atmospheric window is the name given to this wavelength range. A coating can effectively exploit infrared radiation for cooling when it interacts with the atmosphere through this window.

The spectral radiance of a blackbody at a particular temperature is described by Planck's law, which governs this process. Heat can be radiated away from a surface, which is usually designed to achieve certain spectral and angular emissivity characteristics.

(1) For a surface facing the clear sky with an area ‘A’, the total heat flux of a radiative cooling device can be expressed as:

$${\dot{Q}}_{t} ( {T}_{s} , {T}_{a} ) = {\dot{Q}}_{s o l a r} + {\dot{Q}}_{s k y} ( {T}_{s k y} ) - {\dot{Q}}_{r} ( {T}_{s} ) - {\dot{Q}}_{c}$$

where Tₛ is the surface temperature and Tₐ the ambient temperature, \dot{Q}_{sky} is the absorbed irradiation from the sky at an effective sky temperature T_{sky}, \dot{Q}ₛₒₗₐᵣ is the absorbed solar irradiation, \dot{Q}ᵣ (Tₛ) is the radiation emitted from the surface and \dot{Q}_{c} is the non-radiative heat transfer from the body.

Sky can be assumed to radiate at its effective sky temperature, T_{sky} and the deep space is (2) body at absolute zero temperature. The radiation emitted from the surface can be expressed as:

$${\dot{Q}}_{r} ( {T}_{s} ) = {\int }_{0}^{π / 2} 2 π sin θ cos θ {\int }_{0}^{∞} {ε}_{s λ} {E}_{b λ} ( {T}_{s} ) d λ d θ$$

ε_{sλ} is the spectral and directional emittance of the surface, θ is the zenith angle, E_{bλ}(Tₛ)

(3) blackbody spectral emissive power of the surface at Tₛ. By using Kirchhoff's law to replace we surface spectral absorptance with its spectral emittance, the absorbed heat flux from the atmospheric irradiation by the body is expressed as:

$${\dot{Q}}_{s k y} ( {T}_{s k y} ) = {\int }_{0}^{π / 2} 2 π sin θ cos θ {\int }_{0}^{∞} {ε}_{s λ} {E}_{b λ} ( {T}_{s k y} ) d λ d θ$$

solar radiation absorbed by the body may be found by using AM1.5 solar spectrum (International. ASTM G173-03 (2012), Standard Tables for Reference Solar Spectral Irrac Direct Normal and Hemispherical on 37° Tilted Surface).

$${\dot{Q}}_{s o l a r} = {\int }_{0}^{∞} {I}_{A M 1.5} ( λ ) {ε}_{s λ} d λ$$

the non-radiative heat flux can be written as:

$${\dot{Q}}_{c} = {h}_{c} ( {T}_{a} - {T}_{s} )$$

In equation 1, if \dot{Q}ₜ(Tₛ, Tₐ) is positive, the surface is heating and if it is negative, the surface is cooling. Several recent studies have shown that the surface can be designed such that \dot{Q}ₜ(Tₛ, Tₐ) is negative even when the surface is facing the Sun during the daytime. In order for that to happen the surface should have an emittance less than 0.05 in the solar wavelength range (<2.5 μm) and more than 0.9 in the atmospheric window (8 μm-13 μm). The maximum attainable temperature depression of the surface (ΔT=Tₛ−Tₐ) is the temperature Tₛ at which \dot{Q}ₜ reaches zero. Hence, the heat flux is used as the key metric to quantify the cooling power for a given surface area.

### Coating Compositions

Disclosed herein in one aspect is a coating composition, comprising particles comprising one or more of barium sulfate, calcium carbonate, silica, wollastonite, muscovite mica, and aluminum phosphate; and a binder comprising one or more of sodium silicate, polyvinylidene fluoride, and polymethyl methacrylate. The disclosed compositions should emit infrared radiation from 8 to 13 μm wavelengths, for example, at from 8 to 10 μm, from 8 to 11 μm, from 8 to 12, μm, or ideally from 8 to 13 μm. Further, the disclosed compositions should absorb infrared radiation from 8 to 13 μm wavelengths, for example, at from 8 to 10 μm, from 8 to 11 μm, from 8 to 12, μm, or ideally from 8 to 13 μm. Moreover, the disclosed compositions should be highly reflective of visible light.

Specific examples of coating compositions disclosed herein include barium sulfate with sodium silicate, barium sulfate with polyvinylidene fluoride, and barium sulfate with polymethyl methacrylate; calcium carbonate with sodium silicate, calcium carbonate with polyvinylidene fluoride, and calcium carbonate with polymethyl methacrylate; silica with sodium silicate, silica with polyvinylidene fluoride, and silica with polymethyl methacrylate; wollastonite with sodium silicate, wollastonite with polyvinylidene fluoride, and wollastonite with polymethyl methacrylate; muscovite mica with sodium silicate, muscovite mica with polyvinylidene fluoride, and muscovite mica with polymethyl methacrylate; and aluminum phosphate with sodium silicate, aluminum phosphate with polyvinylidene fluoride, and aluminum phosphate with polymethyl methacrylate. Any of these combinations can further include titanium dioxide, barium sulfate, and/or calcium carbonate.

In some specific examples, the particles comprise barium sulfate and calcium carbonate and the binder comprises polymethyl methacrylate.

The particles in the disclosed compositions can be micro or nanoparticles. For example, particles comprising one or more of barium sulfate, calcium carbonate, silica, wollastonite, muscovite mica, and aluminum phosphate can be from about 0.30 μm to about 3.0 μm, with specific examples including from about 0.30 μm to about 0.50 μm, about 0.50 μm to about 0.80 μm, about 0.80 μm to about 1.0 μm, about 1.0 μm to about 1.5 μm, about 1.5 μm to about 2.0 μm, about 2.0 μm to about 2.5 μm, about 2.5 μm to about 3.0 μm, about 0.30 μm to about 1.0 μm, about 1.0 μm to about 2.0 μm, and about 2.0 μm to about 3.0 μm. It can be preferable that the particles can have a heterogeneous distribution, that is, they are not all sized within the same narrow range. As an example, the particles can be evenly distributed over the about 0.30 μm to about 3.0 μm range. By “evenly distributed” is meant that each subrange within the about 0.30 μm to about 3.0 μm range has substantially the same number of particles. In other examples, the particles can be multi-modally distributed over the about 0.30 μm to about 3.0 μm range. That is, there are more than one group or subpopulation of size ranges with different amounts of particles.

In specific examples, while there are particles within the about 0.30 μm to about 3.0 μm range, there can be other particles outside of these ranges, e.g., less than about 0.30 μm and/or more than about 3.0 μm. These particles can be present in an amount that fill in gaps in the particle packing, achieving a hierarchical particle size distribution that optimizes particle volume concentration. These distributions of particles can result in Appollonian packing.

In some additional aspects, the particles are spherical. For example, the particles can have a micro-spherical form. In other examples, some of the particles are irregularly shaped to help fill in the gaps between spherical particles to increase packing density.

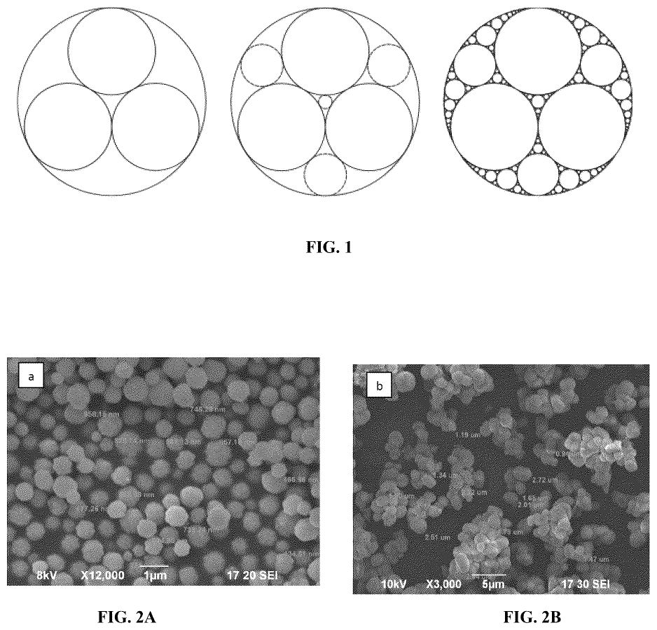

Having particles with sizes distributed over the range from about 0.30 μm to about 3.0 μm can permit the use of Apollonian packing. Spherical geometries can be advantageous for radiative cooling owing to their scattering effect. This characteristic optimizes infrared radiation emission, leading to significantly enhanced heat dissipation efficiency. To increase surface area, a process called Apollonian packing can be used. Apollonian Packing elevates these inherent benefits by strategically maximizing both packing density and surface area exposure. This method incorporates spheres of varying sizes within the material. This approach allows for a higher concentration of particles to be packed efficiently, resulting in a denser material. The increased packing density translates to a greater surface area exposed to the surrounding environment, significantly improving the material's ability to emit infrared radiation and dissipate heat effectively. Furthermore, the design ensures that smaller spheres fill the interstitial spaces between larger ones, leading to a more uniform and consistent cooling effect throughout the material, as illustrated in the FIG. 1.

### Particles

As noted, the disclosed compositions comprise particles comprising one or more of barium sulfate, calcium carbonate, silica, wollastonite, muscovite mica, and aluminum phosphate.

Because AlPO₄ (aluminum phosphate) radiates heat effectively and has good infrared emissivity, it is a highly useful material for passive radiative cooling. Its long-term durability is aided by its chemical inertness and good thermal stability, which can give consistent performance at different temperatures. AlPO₄ can also be used to formulate coatings in a variety of ways due to its compatibility with different binders and its affordability, which makes it a viable option for scaled applications.

Muscovite mica is a natural mineral renowned for its layered structure and exceptional thermal and optical properties. As a member of the phyllosilicate group, muscovite mica is characterized by its high thermal stability, chemical inertness, and ability to maintain structural integrity under extreme conditions. Notably, muscovite mica exhibits high transparency and favorable absorbance in the infrared spectrum, particularly in the 8-11 micrometer region. White mica can also be used.

Wollastonite, a calcium silicate mineral (CaSiO₃), is an abundant and cost-effective material that presents significant advantages for passive radiative cooling applications. Its greyish color is due to its natural mineral composition, but it is particularly valued for its high absorption capabilities in the infrared spectrum, especially within the 9-12 micrometer range. Additionally, its excellent thermal stability and chemical inertness ensure long-term durability and consistent performance in various environmental conditions.

Calcium carbonate (CaCO₃) is a widely used material known for its abundance, cost-effectiveness, and advantageous properties in various applications, including passive radiative cooling. It is a naturally occurring compound found in minerals such as limestone, marble, and chalk. In radiative cooling technologies, CaCO₃ is valued for its excellent thermal stability and high infrared reflectance. Its white colour and ability to reflect a significant portion of visible light make it an effective material for reducing heat absorption and enhancing cooling performance. Additionally, CaCO₃ exhibits notable absorption peaks in the 11-12 micrometer region, which contributes to its effectiveness in radiative cooling by enhancing thermal emission in this critical range.

Barium sulfate (BaSO₄) is a white crystalline solid known for its high density and excellent light-scattering properties. It is widely used in various applications, including as a radiopaque agent in medical imaging and as a pigment in paints and coatings. In the context of passive radiative cooling, BaSO₄ is highly valued for its high solar reflectance and high thermal emissivity, particularly in the 8-10 micrometer range, which make it an effective material for reducing heat absorption and enhancing cooling performance.

If more than one particle are used, they can be present in the disclosed compositions in any weight ratio, e.g., from 10:1 to 1:10, such as from 9:1, 8:1, 7:1, 6:1, 5:1, 4:1, 3:1, 2:1, 1:1, 1:2, 1:3, 1:4, 1:5, 1:6, 1:7, 1:8, or 1:9. In a specific example, two different particles, e.g., barium sulfate and calcium carbonate, can be present in a weight ratio of 2:1.

### Binders

Binders can be used to enhance the overall performance and longevity of the material used in the formulation of passive radiative cooling coatings. In addition to keeping the pigment particles together, binders also affect adhesion, flexibility, and weather resistance of the coating. The thermal emissivity and solar reflectance of the coating can be improved with the appropriate binder selection, for long-term performance under real-world circumstances. Specific examples of binders that can be used are a one or more of sodium silicate, polyvinylidene fluoride, and polymethyl methacrylate.

The weight ratio of particles to binder in the disclosed compositions can be from 4:1 to 1:1, e.g., from 2:1, 4:3, 1:1, or 3:1. In a specific example, the weight ratio of particles to binder can be 4:1.

In specific examples, polymethyl methacrylate (acrylic) is used with water. For example, acrylic can be combined with a solvent such as acetone, and then a small amount of water can be added to enhance the reflectiveness of the composition. Water can be present in the composition at from less than 10 wt. %, e.g., less than 5, 2, or 1 wt. %.

In some examples, the binder is mixed to create micro air pockets and appears white. In other examples, the binder is mixed with no air pockets and appears transparent.

### EXAMPLES

The following examples are set forth below to illustrate the compounds, compositions, and methods claimed herein, along with associated methods and results according to the disclosed subject matter. These examples are not intended to be inclusive of all aspects of the subject matter disclosed herein, but rather to illustrate representative methods and results. These examples are not intended to exclude equivalents and variations of the present disclosure, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

All IR absorbance testing was performed using a Perkin Elmer Spectrum 100 FTIR, a Fourier-transform infrared spectrometer. UV-visible testing was conducted using an Ocean Optics Spectrometer USB 2000 paired with a DH-2000-BAL light source. The measurements were conducted using a probe holder stand. All reflectance measurements were calibrated using a Spectralon reflectance standard, which was purchased from Ocean Optics. Spectralon is a highly reflective, diffusely reflecting material used as a standard in calibration and measurement applications. Surface morphology was observed using a scanning electron microscope (SEM) at 7.5 kV to examine the sample's microstructure.

The outdoor testing setup for measuring temperature readings included a cardboard box designed to minimize conduction and convection effects. Each box was lined with Styrofoam and covered with aluminum foil to minimize heat transfer and ensure consistent testing conditions. Thermocouples attached to the back side of the samples using insulating tape, recorded the temperatures. The sample size was 6 inches by 6 inches. Additionally, the samples were elevated to minimize the influence of nearby buildings and other environmental factors. Additionally, a Stevenson screen, similar to those used in weather stations for accurate ambient temperature measurements, was used to measure ambient temperature. This enclosure shields the thermometer and other instruments from direct sunlight, precipitation, and other environmental influences, allowing for reliable readings of true ambient air temperature. By minimizing the impact of radiative heat and wind, the Stevenson screen creates a controlled environment where the temperature measurement reflects the actual atmospheric conditions rather than fluctuations caused by external factors.

### Experimental Study 1

### Aluminum Phosphate

To prepare AlPO₄, phosphorus pentoxide (P₂O₅) was first added to water while stirring rapidly until the solution became clear. This clear solution was then combined with aluminum nitrate nanohydrate [Al(NO₃)₃·9H₂O] in a molar ratio of 1.5:1 (Al:P). The resulting mixture was stirred continuously for 2 hours. After stirring, the solution was dried at 105° C. to obtain a white AlPO₄ powder. The procedure followed in this study was adapted from (Na Li, et al.,

Polyesterification synthesis of amorphous aluminum phosphate thermal radiation material with high infrared emissivity, Materials Letters, 2018, 213:335-337). The dried AlPO₄ powder was then calcined at three different temperatures to investigate changes in its infrared absorbance. The objective was to determine if structural changes due to calcination affect or broaden the absorbance peak in the 8-13 micrometer region.

The infrared absorbance spectra of the calcined AlPO₄ powders were analyzed to assess changes in the infrared peak over the 8-13 micrometer region. Contrary to expectations, the peak did not broaden with calcination. However, AlPO₄ remains an option for radiative cooling applications due to its strong absorbance peak in the 8-10 micrometer range.

### Muscovite Mica

The mica specimens were placed in a Fritsch Pulverisette 6 ball milling device for size reduction. The milling process involved varying parameters to determine the optimal conditions. The final parameters used were 500 rpm, with a milling time of 10 minutes, followed by a pause time of 3 minutes between each of the 3 repetitions. These conditions effectively reduced the mica to a fine powder suitable for incorporation into coatings, ensuring even dispersion and effective integration into the coating matrix.

Once the powder was prepared, infrared absorption testing was conducted to assess its viability for radiative cooling applications. The results indicated that muscovite mica exhibits a strong absorption peak around 8-12 micrometers, making it an option for radiative cooling due to its effective thermal emission properties in this range.

However, the brownish color of the muscovite mica affects its visible light reflection. The brown mica shows very little reflection in the visible light range. To address this, powdered white mica, which is commonly used in cosmetics, was used. This white mica exhibited similar infrared absorption properties but with a white color. Although this mica has a glittery finish that increases visible light reflection slightly, it does not significantly enhance reflection.

Since mica naturally exhibits irregular shapes, various approaches were explored to modify its structure, aiming to achieve a more spherical form. However, despite these efforts, a method to convert mica into a uniform spherical shape could not be identified.

### Wollastonite

Wollastonite inherently has an irregular, fibrous shape, and various methods were attempted to alter its structure into a more spherical form to potentially improve packing density. Despite these attempts, no effective method to achieve a uniform spherical shape was found.

### Silica Microspheres

Because of their durability, vast surface area, and uniform size, silicon dioxide (SiO₂) microspheres, also known as silica microspheres, are spherical particles formed of silica that are widely employed in many different applications. For passive radiative cooling applications, silica microspheres are prized for their high reflectivity, thermal stability, and effective light scattering. The synthesis of silica microspheres involved a modified Stöber method. Ethanol was diluted with water and sonicated for 10 minutes in an ultrasonicator. TEOS (tetraethyl orthosilicate) was then added to the mixture, followed by an additional 20 minutes of sonication. NH₄OH (ammonium hydroxide) was added dropwise, forming a white turbid solution. Sonication continued for 60 minutes. The resulting silica microspheres were filtered, washed, and dried in an oven. After drying, a white powder of monodisperse silica microspheres was obtained. The procedure followed in this study was adapted from (Kota Sreenivasa Rao, et al., A novel method for synthesis of silica nanoparticles, Journal of Colloid and Interface Science, 2005, 289 (1): 125-131).

Scanning Electron Microscopy (SEM) images of the silica microspheres were captured using the JEOL JSM-6490 Scanning Electron Microscope. These images reveal the formation of silica microspheres with particle sizes ranging from 500 nm to 2 micrometers. This variation in particle size is beneficial, as it contributes to a dense packing structure when used in coating systems, often resulting in improved performance. There was good infrared absorption of silica in the 8-10.5 micrometer range with a small peak in 12-13 micrometer region. Furthermore, compared to mica, its white tint offers superior visible light reflection.

### Calcium Carbonate

Different preparation methods were explored to form calcium carbonate (CaCO₃) microspheres of various sizes. After multiple iterations, the dropwise precipitation reaction method, which had been effective for preparing silica microspheres, was selected for its suitability. In this method, sodium carbonate solution was added dropwise to a calcium chloride solution. The resulting mixture was then centrifuged, washed three times to remove excess salt, and dried in an oven at 100° C. overnight.

Initial attempts yielded agglomerated particles with poorly defined spherical shapes. To address this issue, ethylenediamine tetraacetic acid (EDTA) was introduced into the calcium chloride solution at the same concentration (0.1 M). EDTA forms a complex with calcium ions, which aids in the formation of properly shaped spherical calcium carbonate particles. The procedure followed in this study was adapted from (E. Altay, et al., Morphosynthesis of CaCO₃ at different reaction temperatures and the effects of PDDA, CTAB, and EDTA on the particle morphology and polymorph stability, Powder Technology, 2007, 178 (3): 194-202).

Subsequently, visible light reflection and infrared absorption tests were conducted on these calcium carbonate particles. The results demonstrate that calcium carbonate effectively absorbs in the 11-12 micrometer range. Additionally, being white in color, it exhibits good visible light reflection.

### Barium Sulfate

Various methods were used for the preparation of barium sulfate (BaSO₄). These methods included direct precipitation, direct precipitation with temperature changes, and direct precipitation with varying stirring times to study their effects on the shape and size of the particles. It was found that adjusting the pH in the presence of EDTA produced monodispersed barium sulfate microspheres and nanospheres.

The process involved taking a 0.1M solution of barium chloride and adding a 0.1M solution of EDTA to it while rigorously stirring the mixture. The pH was then adjusted to different values before adding a sodium sulfate solution to the mixture while stirring at a high setting for one minute. As the pH increases, the strength of the EDTA (ethylene diamine tetra acetic acid) complexation also increases, leading to larger and more widely separated particles. This trend highlights the significant impact of pH on the particle size and dispersion characteristics.

Once the resultant solution was prepared, it was centrifuged to allow the barium sulfate to settle. The precipitate was washed three times to remove excess salt. Silver nitrate was used to test for the presence of salt in the wash water, and the washing process continued until the solution was salt-free. The purified barium sulfate was then dried in an oven overnight, resulting in a powdered form of BaSO₄ suitable for use in paint.

Subsequent visible light reflection and infrared absorption tests were conducted on these barium sulfate particles. The results demonstrate that barium sulfate effectively absorbs in the 8-10 micrometer range. Additionally, being white in colour, it exhibits excellent visible light reflection properties. This combination of high reflectivity and effective infrared absorption makes BaSO₄ a good option for radiative cooling applications.

The reflection sometimes exceeds 100% in certain regions because this spectrum is relative, measured against Spectralon, which is also made from barium sulfate. It shows that the reflectance is 100%. The measurements also depend on the packing of the material. To ensure consistent testing conditions, we placed the materials in the cap of a centrifuge tube before taking readings, so that each sample was tested under the same conditions.

In summary, the suitability of AlPO₄, muscovite mica, wollastonite, silica microspheres, calcium carbonate, and barium sulfate for use in passive radiative cooling applications was evaluated and examined. Each material's unique characteristics, such as its ability to reflect visible light and absorb infrared were carefully examined. The potential of these materials in real-world applications was next investigated by testing them with various binders.

### Binders

The testing of several binders, such as sodium silicate, siloxane, acrylic, and PVDF, are discussed herein. The compatibility of each binder with the components previously discussed was assessed, with an emphasis on maximizing the stability and cooling capabilities of the finished coatings.

### Polydimethylsiloxane (PDMS)

Polydimethylsiloxane (PDMS), a prominent siloxane-based polymer, was chosen for testing as a potential binder due to its unique properties, including flexibility and thermal stability. The absorbance of PDMS, purchased from Fisher Scientific (Cat No. AA43769AK), was evaluated to determine its effectiveness in the infrared spectrum. In the regions of interest, PDMS exhibits two prominent absorption peaks, one at 12-14 micrometers and the other at 8.5-10.5 micrometers. Because of these properties, it is an option for improving the infrared emission in passive radiative cooling coatings.

However, PDMS's being a transparent liquid is a significant drawback. Because of its transparency, it is less effective in reflecting visible sunlight, which is necessary for optimal cooling. Despite this disadvantage, PDMS's infrared performance indicates that the entire atmospheric transparency window can be efficiently covered when combined with a material that provides significant absorption in the 8-9 and 11-12 micrometer bands. As a result, as described in the Results section, numerous coatings containing PDMS were tested to determine their overall effectiveness.

### Sodium Silicate

Another silicate-based material chosen was sodium silicate for its capacity to promote radiative cooling. Sodium silicate (Cat. No. S25566) was obtained from Fisher Scientific due to the effectiveness of silicates such as mica, wollastonite, and silica in passive radiation cooling applications. Its performance in the infrared spectrum was assessed using absorbance. Strong absorption peaks were discovered in the 9-11 micrometer range, and the absorbance gradually rose until it reached 18 micrometers.

This shows that if the absorption in the 8-9 and 11-13 micrometer ranges is improved, sodium silicate has the potential to cover a significant portion of the atmospheric transparency window. However, like PDMS, liquid sodium silicate's transparency restricts the quantity of visible light that may be reflected from the sun, reducing the material's cooling power. As discussed in subsequent sections, this can be solved by adding more materials to create a cooler surface.

### Polyvinylidene Fluoride (PVDF)

Polyvinylidene Fluoride (PVDF) is a highly durable and chemically resistant fluoropolymer known for its excellent weatherability and high thermal stability. PVDF has strong absorption peaks in the 8-10 micrometer and 11-12.5 micrometer ranges. As a result, PVDF is an alternative for radiative cooling applications, especially when combined with materials with strong absorption in the 10-11 micrometer range. PVDF's ability to dissolve in solvents such as acetone or DMSO to produce a clear liquid that turns white when dry increases its effectiveness by boosting solar visible light reflection.

### Acrylic

Acrylic is a versatile polymer that is widely used due to its low cost and availability. Plexiglass, a typical type of acrylic, was chosen for this study due to its availability and low cost on the market. To create a binder solution, plexiglass was dissolved in acetone.

After dissolving, the mixture was distributed evenly over an aluminum surface and left to dry. After that, the coating's ability to absorb infrared light was tested. The acrylic coating demonstrated promising absorbance peaks in the 8-10 micrometer range, with lower peaks in other parts of the atmospheric transparency window.

The coating's performance was enhanced by the use of phase inversion techniques. Adding water to the acetone and acrylic mixture significantly improved visible light reflection. This change means that, while the acrylic provides a good basis for infrared absorbance, other adjustments are required to maximize visible light reflection and improve absorption across the entire atmospheric window.

To better understand the impact of phase inversion, a zoomed comparative reflectance of plexiglass (Acrylic) with and without water was performed. The data show that the visible light reflectance increases by an average of 4-7% across the 400-800 nm range. These findings imply that acrylic-based coatings can be used in radiative cooling, particularly when combined with other materials to boost infrared absorption and visible light reflection.

### Results

Silica microspheres were initially chosen for their white color, which, when paired with an ideal binder, could collectively cover the atmospheric window. Silica microspheres are known for their strong peak in the 8-10 μm region. However, to achieve full coverage of the infrared spectrum, a complementary component was needed.

Polydimethylsiloxane (PDMS) was first used as a binder. Numerous iterations were tested to create a balanced mixture that could function as a paint. Absorption results revealed minimal improvement across different concentrations of silica and PDMS, with the absorption behavior remaining similar to that of pure siloxane. This highlighted the dominant role of siloxane in the mixture, making it unsuitable for creating an effective paint with silica.

Further analysis revealed that the high refractive index and structural properties of PDMS might have led to scattering effects that masked the radiative cooling benefits of silica microspheres. Attempts to modify the silica particle size and surface treatment did not yield the desired improvements in spectral coverage. Additionally, the inherent hydrophobicity of PDMS posed challenges for uniform particle dispersion, impacting the coating's optical properties. Consequently, alternative binders with lower interference and better compatibility with silica were explored to achieve a more optimized formulation for effective radiative cooling.

Despite these challenges, the mixtures were tested outdoors to assess their effectiveness. The coated samples exhibited higher temperatures compared to the uncoated aluminum substrate, indicating that the coating failed to fully cover the 8-13 μm range and did not adequately reflect UV and sunlight rays. The significant influence of PDMS was evident, as it seemed to control the coating's behavior, leading to uneven and ineffective coverage.

Next, two types of mica were tested: mica flakes and commercially available white mica powder. The mica flakes were ball-milled at a specific speed to produce a fine powder suitable for incorporation into a paint with a binder. Siloxane was used as the binder, but it proved too dominant, resulting in no significant change in infrared absorption.

Subsequently, white powdered mica was tested with siloxane, but similar problems occurred. To further confirm the dominance of siloxane, muscovite mica was powder-coated directly onto an aluminum substrate and tested outdoors. The results showed better performance than aluminum and approaching that of commercial paint (Sta-Kool). These results indicated that siloxane is not suitable for cooling applications.

Sodium silicate was then combined with mica to see if it would improve performance. The mixture was tested for infrared absorption, and the results showed a broader absorption peak in the 8.5-12 μm region compared to sodium silicate alone. However, outdoor testing indicated that the temperature was higher than those of the commercial paints. The creamish color of mica was likely affecting visible light reflection.

Barium sulfate was added to the mica powder in a 1:1 ratio to test for improvements in infrared absorption. This powder mixture showed good results, covering the 8-12 μm region completely, but additional coverage was needed to fully address the atmospheric window. When this mixture was added to the sodium silicate solution, the results mirrored those observed with sodium silicate and mica alone. The combination demonstrated a comparable bonding strength and stability, indicating that the additional components had minimal impact on the overall matrix behavior.

The addition of a white powder to any color tends to balance the color rather than changing the entire sample to white, which is necessary for achieving optimal visible light reflection. It became clear that a white material was needed, with sodium silicate serving as a binding agent that also absorbs in the infrared region. To address this requirement, aluminum phosphate was chosen for further testing due to its white color and its strong peak in the 8-10 μm region. The combination of aluminum phosphate with sodium silicate was explored to enhance the performance of the coating.

Aluminum phosphate was tested in combination with sodium silicate, leveraging aluminum phosphate's strong absorption peak in the 8-10 μm range while relying on sodium silicate to cover the remaining spectral window. The results indicated good coverage of the atmospheric window, but the mixture was lacking in the 10.5-12 μm region.

This deficiency likely contributed to the temperature rise, which did not improve beyond the commercial paint (Sta-Kool). Two concentrations of aluminum phosphate were tested (5% and 10%), and although the material showed promise in the infrared region, it did not achieve the desired cooling effect.

TABLE 1
Outdoor Testing Results of AlPO4 with Sodium Silicate Samples

| | |
|---|---|
| Type of Sample | Time |

| — | 12:30 pm | 1:30 pm | 2:30 pm |
|---|---|---|---|
| Aluminum | 39.8° c. | 50.7° c. | 51.2° c. |
| 10% AlPO₄ in Sodium | 35.9° c. | 50.5° c. | 42.5° c. |
| Silicate | | | |
| 5% AlPO₄ in Sodium | 45.9° c. | 51.8° c. | 47.2° c. |
| Silicate | | | |
| Commercial Paint | 43.4° c. | 47.7° c. | 38.3° c. |

It was found that aluminum phosphate absorbs in the UV and mid-infrared ranges, potentially causing heating effects rather than cooling. Additionally, sodium silicate's transparency did not significantly aid in visible light reflection. A new testing setup was devised following the earlier results with aluminum phosphate and sodium silicate. The goal was to address the lack of coverage in the 10.5-12 μm region and improve cooling performance. This time, polymer-based coatings were selected, beginning with polyvinylidene fluoride (PVDF). When dissolved in acetone, PVDF forms a clear liquid that dries into a white coating, which aids in visible light reflection while also strongly absorbing in the atmospheric window. To complement PVDF and achieve full absorption across the 8-13 μm range, wollastonite was chosen after several iterations.

Though wollastonite has a slightly greyish color, it paired well with PVDF. After testing, an optimal combination was achieved: 5 g of PVDF pellets dissolved in acetone mixed with 15 g of wollastonite. The resulting coating was applied to an aluminum surface and tested against various commercial paints. The coating's temperature was consistently lower than all commercial paints, marking a significant success. Despite the success, ambient temperature comparisons revealed that while the PVDF+wollastonite coating outperformed commercial paints, it still remained above ambient.

After numerous iterations aimed at finding the optimal coating for sub-ambient temperatures, a double-layer structure was tested. In this setup, a strong emitting layer was placed at the bottom, with a very thin reflective layer on top to balance both visible light reflection and infrared emission. The PVDF+wollastonite combination already covered the full 8-13 micrometer range, so the goal was to find a material that would reflect incoming visible radiation. Various materials, including TiO₂, BaSO₄, and a mixture of CaCO₃ and BaSO₄, were tested. However, none performed as expected. The double-layer structure consistently resulted in higher temperatures than the PVDF+wollastonite coating. Since the double-layer approach failed to achieve the desired effect, the focus shifted toward materials with a bright white finish to enhance reflectivity.

A new binder, acrylic, was selected for its strong absorption in the 8-10 μm range. To enhance its structural properties, a phase inversion technique was employed. A mixture of 6 ml water, 55 ml acetone, and 5 g of plexiglass was prepared and left to settle for 2-3 days, forming an ice-like structure upon drying. Barium sulfate, known for its excellent UV-visible reflectivity and infrared absorption, was chosen for initial testing. Before outdoor trials, the samples were analyzed using an Ocean View UV-Vis spectrometer, which delivered promising results. The PDRC sample (Acrylic+BaSO₄) demonstrated superior visible light reflection compared to three commercial paints.

Encouraged by these results, the samples were then tested outdoors. The performance was impressive, with temperatures consistently 2-3° C. lower than those of commercial paints. However, the coating's coverage was limited to the 8-10 μm range. Calcium carbonate (CaCO₃) was added to address the remaining spectral range, specifically its peak in the 11-12 μm region. A new formulation of 10 g BaSO₄, 5 g CaCO₃, and 5 g acrylic was developed, which further reduced temperatures, bringing them close to ambient. Out of all commercial paints, Henry was the one showing more cooling than others so further results included only one commercial paint, Henry.

Further attempts were made to push the temperature below ambient by adjusting the size of CaCO₃ and BaSO₄ spheres to achieve denser packing. While this improved the performance, the temperature did not fall below ambient, indicating that additional materials were needed to cover the entire 8-13 micrometer range. After extensive trials, no suitable material was found that could fill the gap while maintaining a white appearance.

Initial trials with silica microspheres, while promising in the 8-10 μm infrared range, revealed the need for a complementary component to enhance full-spectrum coverage. PDMS, despite its widespread use, dominated the mixture's behavior and failed to provide the necessary balance for an effective cooling paint. Similarly, efforts to utilize muscovite mica in combination with siloxane encountered similar challenges, with siloxane's dominance limiting infrared absorption and overall cooling performance.

Subsequent trials with sodium silicate, muscovite mica, and barium sulfate highlighted the importance of balancing visible light reflection with infrared absorption. Though some mixtures showed improvements, outdoor testing consistently demonstrated higher temperatures than desired, primarily due to incomplete spectral coverage. The exploration of aluminum phosphate and sodium silicate offered better absorption in targeted infrared regions, but the results were insufficient for sub-ambient cooling.

The introduction of PVDF and wollastonite marked a significant advancement, with their combination offering promising spectral coverage across the atmospheric window and outperforming commercial paints in terms of cooling performance. However, the challenge of achieving a material that could both reflect visible light and cover the full 8-13 μm range persisted. Attempts to refine particle size and packing density of BaSO₄ and CaCO₃ demonstrated incremental improvements, but the coatings remained above ambient temperature. However, the fact that the final coating achieved temperatures below the best “cool” commercial paintings. Since the reflectance of the coating was similar to the reflectance of the commercial paints, a lower temperature means that the absorbed solar radiation was neutralized by the emission of radiation from the surface, which shows that the prepared coatings have achieved IR emission, though not enough to reduce the temperature below ambient.

The coatings developed in this work demonstrated promising performance in reducing surface temperatures compared to commercial paints, indicating that these formulations can reduce the cooling energy in buildings more than the best available commercial paints.

One potential avenue for future exploration is the refinement of the double-layer strategy. The PVDF+wollastonite combination already demonstrates excellent spectral coverage across the 8-13 μm infrared region, but its performance can be further enhanced with a top layer that reflects visible light more effectively.

### Experimental Study 2

Solutions of barium chloride and sodium sulfate were prepared separately. Ethylenediamine tetraacetic acid (EDTA) was added to the barium chloride solution, and the mixture was stirred continuously for 1 hour to ensure complexation. The sodium sulfate solution was added dropwise to the mixture while maintaining constant stirring to promote precipitation. The concentration of EDTA was varied systematically to optimize the conditions and yield nano-sized barium sulfate spheres. A similar procedure was followed for the preparation of calcium carbonate microspheres, where calcium chloride and sodium carbonate solutions were prepared separately. EDTA was added to the calcium chloride solution and stirred for 1 hour, followed by dropwise addition of sodium carbonate solution under continuous stirring. The EDTA concentration was adjusted to achieve the desired microscale calcium carbonate spheres.

Plexiglass, typically in a plastic-like form, was dissolved and processed to enhance its ability to reflect sunlight. Upon dissolution and subsequent coating, the plexiglass exhibits different optical behaviors depending on the drying method. When cold air is used to dry the acrylic solution, it turns white, enhancing its reflective properties. In contrast, when a hot air gun is applied to dry the coating, the acrylic becomes transparent. To achieve optimal sunlight reflection for maximum cooling, the acrylic coating should remain as white as possible. To facilitate this, 5 grams of plexiglass were dissolved in a mixture of 66 mL of acetone and 5 mL of water. The acetone evaporates rapidly, while the slower evaporation of water molecules results in the formation of small air voids in the polymer matrix, creating a snow-like structure that significantly improves the reflection properties.

The acrylic solution was prepared by slowly adding a mixture of calcium carbonate and barium sulfate in a 1:2 ratio, with 40 grams of the powder mixture used for every 10 grams of acrylic. The powder was gradually incorporated into the solution while simultaneously sonicating and stirring to ensure uniform dispersion and prevent the formation of clumps, resulting in an even, homogeneous coating mixture. Once the mixture was prepared, a 6 cm×6 cm aluminum plate was cleaned of any grease using acetone or ethanol. After cleaning, two layers of RUST-OLEUM™ White primer (a mixture of Titanium Dioxide, Hydrotreated Light Distillate, Hydrous Magnesium Silicate, and other additives) were applied to the plate and allowed to dry for about 2 hours, ensuring proper adhesion of the polymer coating to the aluminum substrate. Once the primer dried, a high-pressure gravity spray gun was used to apply the coating to the primed surface. The coating was applied slowly and evenly to avoid clumping or inconsistencies, as even the slightest non-uniformity, such as a crack in the coating, could significantly impact performance.

The samples were placed on a setup comprising Styrofoam covered with aluminum foil, which was enclosed in a cardboard box with sufficient height to minimize the effects of ambient conduction and convection on the samples. This configuration also prevented any shadowing effects on the samples. A Stevenson screen was used to measure the ambient temperature, and a datalogger was employed to record the data. K-type thermocouples were affixed to the back side of the samples using an insulating tape to eliminate measurement errors. Ambient temperature measurements indicated a significant increase in the temperature when samples were placed on or above a concrete surface due to heat reflection. Consequently, the samples were positioned above the grass to ensure accurate temperature readings.

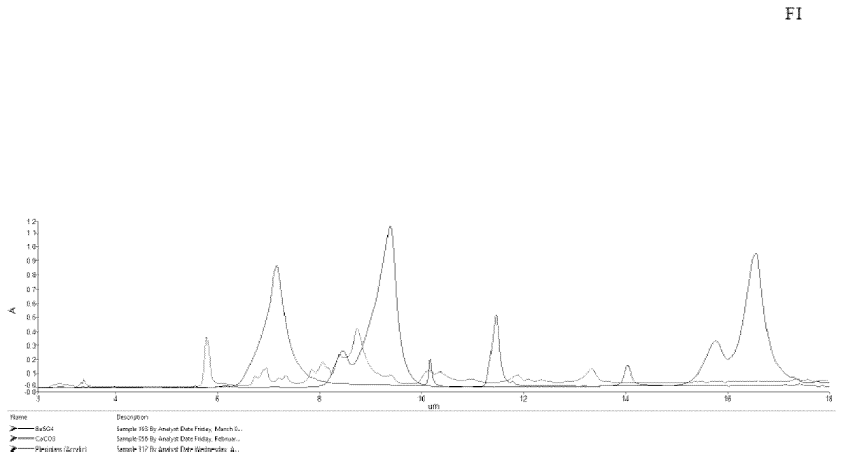

The SEM images of the prepared BaSO₄ and CaCO₃ particles are shown in FIGS. 2A and 2B. respectively. FIG. 2A displays the BaSO₄ nanospheres, which exhibit a size range from 335 nm to 958 nm, while FIG. 2B presents the CaCO₃ microspheres, with sizes ranging from 0.94 μm to 2.51 μm. The selected materials, BaSO₄ and CaCO₃, allow for the controlled preparation of particles in both the nano and micro ranges. Therefore, consistent particle sizes for each batch are achieved.

FIG. 3 illustrates the infrared absorption spectra of BaSO₄, CaCO₃, and acrylic. As shown in the figure, BaSO₄ particles (darkest line) exhibit a pronounced absorption peak in the 8-10 μm range, which is ideal for efficient radiative cooling as it aligns with the atmospheric window. Similarly, CaCO₃ particles (dark grey line) show a strong absorption peak around 11-12 μm, another critical region for effective heat dissipation in the atmospheric window. Acrylic (light grey line) as the polymer matrix, contributes by covering the remaining infrared region, showing smaller peaks distributed throughout the 8-13 μm range. This broad absorption profile enables the polymer to effectively support the radiative cooling mechanism by allowing for the emission of thermal energy through the atmospheric window in the infrared spectrum. The synergy between the high infrared emission of BaSO₄ and CaCO₃ particles, and the versatile emission characteristics of the acrylic matrix, makes this composite material well-suited for efficient heat radiation emission through the atmospheric window.

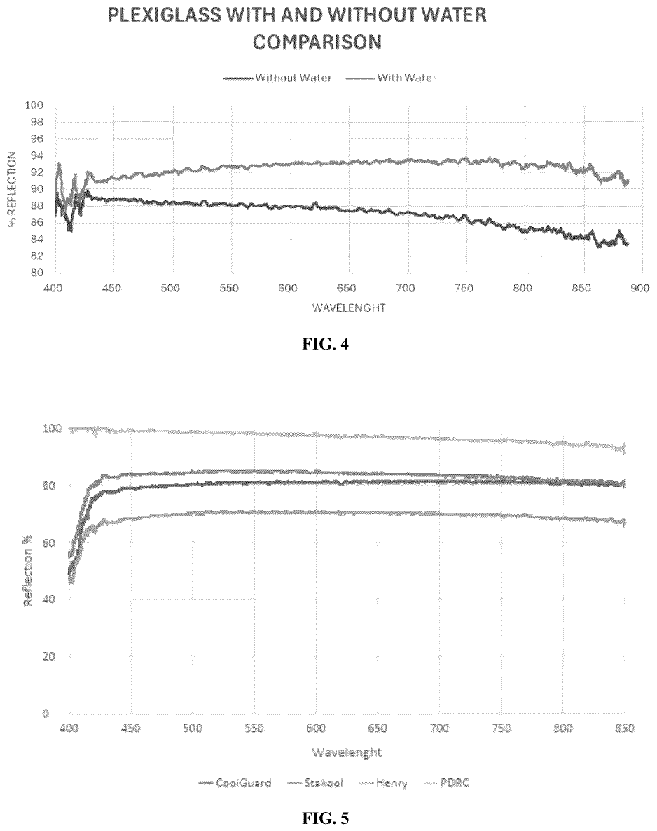

FIG. 4 demonstrates the effect of adding water to the acrylic solution on the reflection of sunlight. The graph shows two curves: the black line represents the acrylic coating prepared with acetone without the addition of water, while the grey line represents the acrylic coating with acetone prepared with acetone of water in a 55:6 acetone-to-water ratio. This ratio plays a role in enhancing the reflectivity of the coating. Based on the various acetone-to-water ratios tested, 55:6 ratio exhibited the best performance, showing a significant increase in reflectivity in the 400-900 nm range. Specifically, a 4-7% difference in reflection was observed compared to the acrylic coating without water. The presence of water during the preparation process leads to the formation of small pores within the polymer matrix due to slower evaporation, which increases the surface roughness and results in enhanced diffuse reflection. This improved reflection is essential for the effective solar cooling performance of the paint. The coating was named Passive Daytime Radiative Cooling (PDRC) or PDRC1.

Before conducting outdoor testing, the solar reflectivity of the prepared Passive Daytime Radiative Cooling (PDRC1) paint was compared with several commercially available paints, including Lanco Cool Guard, Gardner Sta-Kool, and Henry. This comparison was made to assess the visible light reflection performance of our PDRC 1paint. The results are shown in FIG. 5.

As shown in FIG. 5, the lightest line represents PDRC1, the darkest line represents Lanco Cool Guard, the next darkest line corresponds to Gardner Sta-Kool, and the next lightest line represents Henry. The results indicate that the PDRC1 paint outperforms the commercial paints in terms of solar reflectivity. Specifically, the PDRC1 exhibits a reflection that is approximately 15-16% higher than Gardner Sta-Kool, 18-20% higher than Lanco Cool Guard, and 30-32% higher than Henry in the 400-850 nm range. These results provide a clear indication of the superior solar reflectivity of the PDRC paint, which contributes to its enhanced cooling performance. It is important to note that all samples were maintained at a uniform thickness to ensure accurate and error-free results.

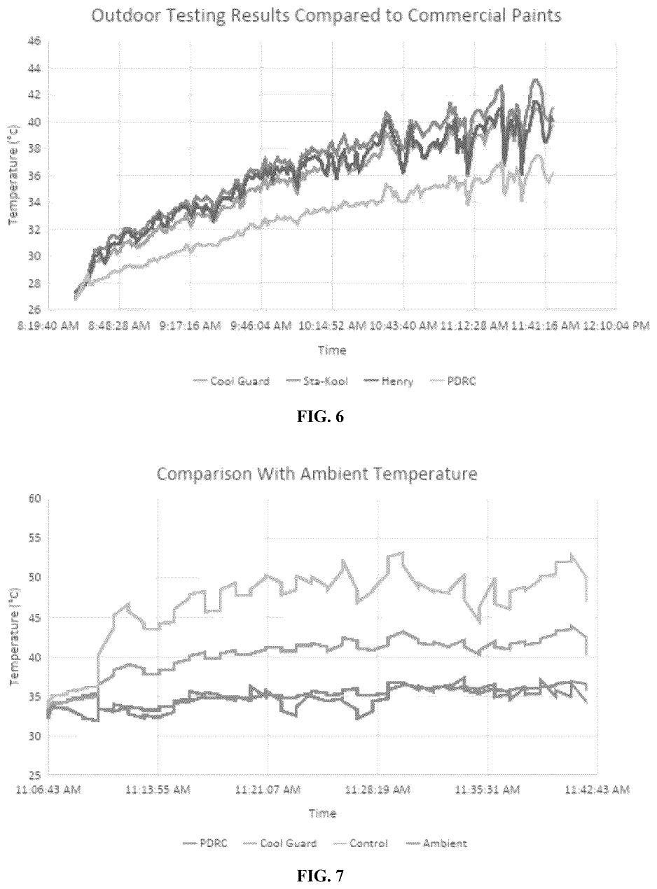

Given the superior performance of the PDRC paint in the visible light region, outdoor temperature testing was conducted under clear sky conditions. This test aimed to evaluate the real-world cooling effectiveness of the PDRC1 paint compared to commercially available paints. The paints tested included Lanco Cool Guard (next lightest line), Gardner Sta-Kool (next darkest line), Henry (darkest line), and the PDRC paint (lightest line). The results are shown in FIG. 6.

To ensure consistency, all samples were initially kept under a shaded area for a few minutes to equalize their starting temperatures. Afterward, the shed was removed, and the samples were exposed to direct sunlight. As shown in FIG. 6, the temperature of the commercial paints increased significantly upon exposure to sunlight, whereas the temperature of the PDRC1 paint also rose but remained consistently 2-3° C. lower than that of the commercial paints. This demonstrates the superior cooling performance of the PDRC paint in outdoor conditions.

The results underscore the potential of the PDRC1 paint as an effective alternative to existing commercial paints. Additionally, its compatibility with industry-standard manufacturing techniques highlights its feasibility for large-scale commercialization.

FIG. 7 illustrates the temperature comparison between the PDRC1 sample and ambient temperature under clear sky conditions. As shown in the graph, the temperature of the PDRC1 coating (represented by the next lightest line) remained consistently at the average ambient temperature depicted by the blue line. The PDRC1 also showed lower fluctuations than the ambient temperature. The control sample, which was an uncoated aluminum substrate (lightest line), demonstrated significantly higher temperatures, remaining around 20° C. above the PDRC sample at all times, thus indicating the effectiveness of the PDRC1 paint in maintaining a lower surface temperature. To assess the relative performance, Lanco Cool Guard was selected for comparison due to its relatively better performance in earlier tests, shown as the grey line in the graph. The PDRC1 sample was consistently about 5° C. lower than the best-performing commercial paint, even when exposed to direct sunlight for prolonged periods. These tests confirm that the PDRC1 paint not only outperforms the commercial paints but also offers a promising pathway toward energy-efficient, scalable radiative cooling solutions.

The result showing that the PDRC1 paint maintains a temperature equal to the ambient temperature under some conditions is significant because it means that PDRC emits as much radiation in the IR range as it absorbs from the solar spectrum. Further optimization of the particle sizes and distribution can result in PDRC achieving temperatures below ambient while facing direct sunlight on a clear day. The scalability of the PDRC paint production method, its ease of manufacturing, and low cost suggest that this method shows a pathway to achieve cost-effective PDRC self-cooling paint.

As disclosed herein, a self-cooling paint as a mixture with a minimum number of low-cost constituents, using manufacturing processes compatible with the standard industrial practices in the cool-roof paint industry. The coating composition achieved surface temperatures consistently ˜5° C. or more below those of commercially available solar cooling paints, even under prolonged exposure to sunlight. The PDRC paint maintained surface temperatures equal to or just below ambient. This shows that the PDRC emits radiation in the IR range at least equal to the radiation it absorbs from Sunlight on a clear day while facing the Sun.

In view of the described compounds, compositions, and methods, hereinbelow are described certain more particular aspects of the disclosure. These particularly recited aspects should not, however, be interpreted to have any limiting effect on any different claims containing different or more general teachings described herein, or that the “particular” aspects are somehow limited in some way other than the inherent meanings of the language and formulae literally used therein.

What is claimed is:

1. A coating composition, comprising:
particles comprising one or more of barium sulfate, calcium carbonate, silica, wollastonite, muscovite mica, and aluminum phosphate, wherein the particles have a range of particle sizes from about 0.3 μm to about 3 μm; and
a binder comprising one or more of sodium silicate, polyvinylidene fluoride, and polymethyl methacrylate.

2. The coating composition of claim 1, further comprising particles less than about 0.3 μm and/or more than 3 μm in an amount to result in Apollonian packing.

3. The coating composition of claim 1, wherein the particles have a micro-spherical form.

4. The coating composition of claim 1, wherein one portion of the particles are spherical and another portion of the particles are irregular shaped and fill gaps to increase the packing density.

5. The coating composition of claim 1, wherein the binder is mixed to create micro air pockets and appears white

6. The coating composition of claim 1, wherein the binder is mixed with no air pockets and appears transparent.

7. The coating composition of claim 1, wherein the particles comprise barium sulfate and calcium carbonate, and the binder comprises polymethyl methacrylate.

8. The coating composition of claim 7, wherein the barium sulfate and/or calcium carbonate particles are microparticles.

9. The coating composition of claim 7, wherein the barium sulfate and calcium carbonate particles are present in the composition in a 2:1 weight ratio.

10. The coating composition of claim 7, wherein the barium sulfate and calcium carbonate particles together and polymethyl methacrylate binder are present in a 4:1 weight ratio.

11. The coating composition of claim 7, further comprising acetone and water.

12. The coating composition of claim 1, wherein the particles comprise aluminum phosphate and the binder comprises sodium silicate.

13. The coating composition of claim 12, further comprising barium sulfate and/or calcium carbonate.

14. The coating composition of claim 1, wherein the particles comprise wollastonite and the binder comprises polyvinylidene fluoride.

15. The coating composition of claim 14, further comprising barium sulfate and/or calcium carbonate.

16. The coating composition of claim 1, further comprising an additional coating comprising one or more titanium dioxide, barium sulfate, and calcium carbonate.

17. An article coated with the coating composition of claim 1.

18. A method of coating an article, comprising: contacting the article with the coating composition of claim 1.
